(19) United States
(12) Patent Application Publication
(10) Pub. No.: US 2006/0266986 A1
(43) Pub. Date: Nov. 30, 2006

(54) Fire-resistant threads, fibers, filaments and textile articles

(76) Inventors: Rebecca Day, Worcestershire (GB); Richard Macret, Paulinia-SP- (BR); Iain Morrison, Birmingham (GB); Stephane Remy, Saronno (IT)

Correspondence Address: Jean-Louis Seugnet;Rhodia Inc, 259 Prospect Plains Road, CN 7500, Cranbury, NJ, 08512, US

(21) Appl. No.: 10/546,267

(22) PCT Filed: Feb. 13, 2004
(86) PCT No.: PCT/FR04/00326

§ 371 Date: May 11, 2006

(30) Foreign Application Priority Data
Feb. 21, 2003 (FR) 03/02165

(51) Int. Cl. C09K 21/00

(52) U.S. Cl. 252/608

(57) ABSTRACT

The invention relates to a method for production of fire-resistant threads, fibres, filaments and textile articles from a thermoplastic matrix, whereby at least one fire-retardant agent and/or a composition comprising at least one fire-retardant agent is deposited on the threads, fibres and/or filaments during transport in the course of the production thereof. The invention further relates to fire-resistant threads, fibres, filaments and textile articles

The present invention relates to a process for the manufacture of fire-retardant yarns, fibers and/or filaments based on a thermoplastic matrix, in which at least one fire-retardant agent and/or one composition comprising at least one fire-retardant agent is deposited on the yarns, fibers and/or filaments during their progression during the processes for the manufacture and/or treatment thereof. The invention also relates to fire-retardant yarns, fibers, filaments, textile surfaces and textile articles.

### PRIOR ART

In numerous applications, attempts have been made to protect textile articles from fire and to reduce the propagation of flames by these articles. For example, it is important to employ fire-retardant building or coating materials and clothes. The rendering of thermoplastic compositions fire-retardant has been studied for a very long time. There thus exists numerous fire-retardant agents for compositions based on thermoplastic matrices.

There is a continual search for compositions based on a thermoplastic matrix which have increasingly better fire-retardant properties for the manufacture of yarns, fibers, filaments and textile articles. Furthermore, fire-retardant agents, generally used in large amounts, cause problems in the forming of yarns, fibers and filaments. Moreover, some fire-retardant agents comprising halogens or red phosphorus can generate toxic gases or vapors during the combustion of the polyamide composition. In addition, fire-retardant agents are known to be unstable at high temperatures. Thus, a portion of the fire-retardant agents decomposes during the process for the manufacture of the polyamide, thus reducing their fire-retardant effectiveness. Moreover, fire-retardant agents applied to the surface of woven or knitted textile articles do not withstand washing. The textile articles rendered fire-retardant in this way thus lose their fire-retardant capability with time.

There thus exists a need to develop yarns, fibers and filaments based on a thermoplastic matrix which have satisfactory mechanical properties, good fire retardancy and good resistance to washing while avoiding the abovementioned disadvantages.

### INVENTION

The Applicant Company has demonstrated that the addition of a fire-retardant agent during the process for the manufacture of yarns, fibers and/or filaments makes it possible to obtain textile surfaces and articles having good resistance to flame propagation and to carbonization, even after numerous washing operations.

As the fire-retardant agent is not incorporated in the thermoplastic matrix during the forming thereof, the fire-retardant agent is not modified or detrimentally affected and retains its fire-retardant capabilities. Neither does it react negatively with the thermoplastic matrix and thus it does not cause problems of decomposition, of coloring or of yellowing of said matrix.

The introduction of the fire-retardant agent during the process for the spinning of the yarns, fibers and/or filaments also makes it possible to satisfy the properties desired with regard to cost and ease of processing.

### DETAILED ACCOUNT OF THE INVENTION

The present invention relates to a process for the manufacture of fire-retardant yarns, fibers and/or filaments based on a thermoplastic matrix, in which at least one fire-retardant agent and/or one composition comprising at least one fire-retardant agent is deposited on the yarns, fibers and/or filaments during their progression during the processes for the manufacture and/or treatment thereof.

According to the present invention, the yarns, fibers and/or filaments can be brought into contact with the fire-retardant agent at any point in the progression of the yarns, fibers and/or filaments during the manufacture and/or treatment thereof. One or more depositions on the yarns, fibers and/or filaments can be carried out.

The operation in which the fire-retardant agent is brought into contact with the yarns, fibers and/or filaments begins during the passage through the spinneret of the thermoplastic matrix, in particular when the yarns, fibers and/or filaments exit from the spinneret, and finishes before the stage of manufacture of the textile surface.

The term “textile surface” is understood to mean a surface obtained by assembling yarns, fibers and/or filaments by any process, such as, for example, adhesive bonding, felting, weaving, braiding, flocking or knitting.

The term “yarn” is understood to mean, for example, a continuous multifilament object, a continuous yarn obtained by assembling several yarns or a continuous staple fiber yarn, obtained from fibers of a single type, or from a mixture of fibers.

The term “fiber” is understood to mean, for example, a short or long fiber, a fiber intended to be worked in spinning or for the manufacture of nonwoven articles or a tow intended to be cut to form short fibers.

The process for the manufacture of fire-retardant yarns, fibers and/or filaments according to the invention generally comprises a stage of spinning the yarns, fibers and/or filaments and/or one or more stages of treatment of the yarns, fibers and/or filaments obtained.

The process for the manufacture of yarns, fibers and/or filaments comprises in particular a spinning stage.

The term “spinning stage” is understood to mean a specific operation consisting of the production of yarns, fibers and/or filaments. According to the invention, the spinning stage begins during the passage of the thermoplastic matrix through one or more spinnerets and finishes by the transfer of the yarns, fibers and/or filaments obtained onto a bobbin (for the yarns or filaments) or into a pot (for the fibers), also referred to as winding up. The spinning stage can also comprise stages which are carried out between the stage of passing into the spinneret and the stage of the winding process. These stages can, for example, be stages of sizing, of recombining the filaments (via one or more pick-up points or convergence guides), of drawing, of reheating the filaments, of relaxing and of heat-setting.

Thus, the deposition on the yarns, fibers and/or filaments of at least one fire-retardant agent and/or one composition comprising at least one fire-retardant agent can be carried out during the stage of spinning the yarns, fibers and/or filaments, between the departure from the spinneret of the thermoplastic matrix and the winding up of the yarns, fibers and/or filaments obtained.

The deposition, on the yarns, fibers and/or filaments, of a fire-retardant agent or of a composition comprising at least one fire-retardant agent can be carried out, for example, after the convergence of the yarns, fibers and/or filaments and/or during a stage of drawing the yarns, fibers and/or filaments. Said deposition can also be carried out between these two stages.

Preferably, the fire-retardant agent or the composition comprising at least one fire-retardant agent is deposited on the yarns, fibers and/or filaments during the sizing stage.

According to a preferred subject matter of the invention, a sizing composition comprising at least one fire-retardant agent is deposited on the yarns, fibers and/or filaments.

Said sizing composition can comprise from 0.1 to 30% by weight of fire-retardant agent, preferably from 1 to 20% by weight, more preferably still from 5 to 15% by weight, with respect to the total weight of the composition.

According to the present invention, a fire-retardant agent and/or a composition comprising at least one fire-retardant agent can also be deposited on the yarns, fibers and/or filaments during a treatment stage during the taking up of the yarns, fibers and/or filaments.

The term “treatment stage” is understood to mean treatment stages after taking up the yarns, fibers and/or filaments, such as, for example, texturing, drawing, drawing-texturing, sizing, relaxing, heat-setting, twisting, setting, crimping, washing and/or dyeing stages.

In particular, a fire-retardant agent and/or a composition comprising at least one fire-retardant agent can be deposited on the yarns, fibers and/or filaments during an operation chosen from the group consisting of: relaxing, twisting, setting, crimping, drawing and/or texturing the yarns, fibers and/or filaments.

A sizing composition comprising at least one fire-retardant agent can also be deposited on the yarns, fibers and/or filaments, in particular during a treatment stage during the taking up of the yarns, fibers and/or filaments.

The yarns, fibers and/or filaments can also be placed in a washing and/or dyeing composition comprising at least one fire-retardant agent.

The processes for the manufacture of the yarns, fibers and filaments can vary considerably, in particular in the area of the spinning speed. Depending on the type of process, the products obtained have different properties. Thus, different families of processes for the manufacture of yarns, fibers and filaments are known. Mention is made, for example, of the following high-speed spinning processes: POY (Partially Oriented Yarn) (speed of greater than 3500 m/min), ISD (Integrated Spinning Drawing), sometimes also referred to as FOY (Fully Oriented Yarn), or HOY (Highly Oriented Yarn) (speed of greater than 5500 m/min). Mention is also made of low-speed spinning processes: LOY (Low Oriented Yarn) (speed of less than 3500 m/min). These processes, and more particularly the LOY process, comprise a drawing stage which makes it possible to improve the mechanical properties of said products. This drawing stage is also employed in the manufacture of the monofilaments. Furthermore, depending on the applications, drawing can be applied to all the types of yarns obtained by the processes described above. Thus, the yarns obtained by the POY processes are very often drawn, either directly at the outlet of the spinning process (integrated drawing) or in a separate stage comprising taking up the yarns. These processes are well known to a person skilled in the art. They differ from one another, for example, in the spinning speeds, in the method of cooling at the spinneret outlet and in the possible drawing operations carried out. The processes used and the technical parameters of these processes depend to a large part on the properties of the thermoplastic polymer or of the composition used. Thus, the spinning speeds, temperatures and pressures which it is possible to use are determined with respect to the properties of the polymer or of the composition to be spun, such as, for example, the thermal stability and the melt viscosity.

After bringing the fire-retardant agent into contact with the yarns, fibers and/or filaments, a drawing stage can be carried out, continuously or by taking up, which makes it possible to improve the mechanical properties of the spun products and to obtain, for example, a modulus and a residual elongation at break compatible with the processes in which these products are used.

It is also possible, after bringing the fire-retardant agent into contact with the yarns, fibers and/or filaments, to leave said yarns, fibers and/or filaments, for example, for a few days, before continuing the treatment stages and/or the processes for the manufacture of textile surfaces.

The term “fire-retardant agent” is understood to mean a compound which makes it possible to reduce the propagation of the flame and/or to reduce the carbonization of the yarns, fibers, filaments and/or textile articles. These fire-retardant agents are generally used in fire-retardant compositions and are described in particular, for example, in patents U.S. Pat. No. 6,344,158, U.S. Pat. No. 6,365,071, U.S. Pat. No. 6,211,402 and U.S. Pat. No. 6,255,371, cited here by way of reference.

The fire-retardant agent can be chosen from the group consisting of an organic or inorganic compound based:
on magnesium, such as, for example, magnesium hydroxide;
on aluminum, such as, for example, aluminum hydroxide and aluminum phosphate;
on nitrogen, such as, for example, triazines, cyanuric and/or isocyanuric acid, melamine or its derivatives, such as melamine cyanurate, oxalate, phthalate, borate, sulfate, phosphate, polyphosphate and/or pyrophosphate, products condensed from melamine, such as melam, melem and melon, tris(hydroxyethyl) isocyanurate, benzoguanamine, guanidine, allantoin and glycoluril;
on bromine, such as, for example, PBDPO (polybromodiphenyl oxide), BrPS (polybromostyrene and brominated polystyrene), poly(pentabromobenzyl acrylate), brominated indane, tetradecabromodiphenoxybenzene (Saytex 120), 1,2-bis(pentabromophenyl)ethane, tetrabromobisphenol A and brominated epoxy oligomers;
on chlorine, such as, for example, a chlorinated cycloaliphatic compound, such as Dechlorane Plus® (sold by OxyChem, see CAS 13560-89-9);
on sulfur, such as, for example, thiourea, ammonium thiocyanate, ammonium and/or guanidine sulfamate, sulfamides and sulfonates;
on phosphorus, such as, for example, an inorganic compound, such as phosphoric acid, polyphosphoric acid, pyrophosphoric acid, phosphonic acid, phosphate, polyphosphate, triphosphorous acid, metaphosphoric acid, phosphorous acid, hypophosphorous acid, phosphinic acid, phosphorous ester, phosphinous acid, phosphorous oxide, phosphinic oxide, phosphorous trioxide, and their salts; and/or
on phosphorus, such as, for example, an organic compound, also referred to as an organophosphorus compound, such as organic phosphites, for example trimethyl phosphite, phosphates, for example trialkyl phosphate or triaryl phosphate, organic phosphonates, such as alkyl or aryl phosphonates, or organic phosphinates, such as alkyl or aryl phosphinates.

Use may in particular be made, as organophosphorus compound, of phosphonic or diphosphonic acids, such as cyclic phosphonic acids, such as, for example, 1-hydroxyphospholane oxide or 1-hydroxydihydrophosphole oxide, or noncyclic phosphonic acids, such as, for example, dimethylphosphinic acid, ethylmethylphosphinic acid, diethylphosphinic acid, methyl(n-propyl)phosphinic acid, methanedi (methylphosphinic acid), benzene-1,4-(di-methylphosphinic acid), methylphenylphosphinic acid, diphenylphosphinic acid, isobutyl(ethylmethyl)phosphinic acid, (n-butyl)(methylpropyl)phosphinic acid, amyl(isobutylmethyl)phosphinic acid, isopropyl-(hexylmethyl)phosphinic acid, (n-butyl)(methyloctyl)-phosphinic acid, (n-butyl)(methylphenyl)phosphinic acid, (n-pentyl)diphenylphosphinic acid, the di(n-butyl) ester of hexane-1,6-di(methylphosphinic acid) and the diisobutyl ester of benzene-1,4-di(methylphosphinic acid), phosphine oxides, phosphonates, chlorophosphates and organic phosphates, such as triaryl phosphates, bisphenol A bis(dicresyl phosphate), bisphenol A bis(diphenyl phosphate) (BDP Fyroflex, Akzo Nobel), resorcinol bis(diphenyl phosphate) (RDP Fyroflex RDP), cyclic diphosphate esters, such as, for example, Antiblaze 1045 (sold by Rhodia Consumer Specialities, see CAS No. 42595-45-9), and their salts.

Use may in particular be made of organo-phosphorus compounds of formula (I) and/or (II):

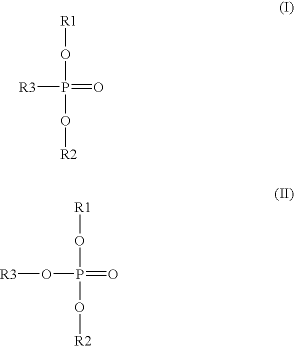

in which R1, R2 and R3 represent, independently of one another, a hydrogen atom or a linear or branched, substituted or unsubstituted and aliphatic, cyclic and/or aromatic hydrocarbon group comprising from 1 to 20 carbon atoms, preferably from 1 to 8 carbon atoms, which can optionally comprise one or more heteroatoms.

The fire-retardant agents mentioned above can be used alone or in combination. The salts of the organophosphorus compounds can, for example, be aluminum, calcium, zinc, alkaline earth metal and/or magnesium salts.

Use may in particular be made, among the compounds of formula (I), of the compounds of formulae (III) and/or (IV):

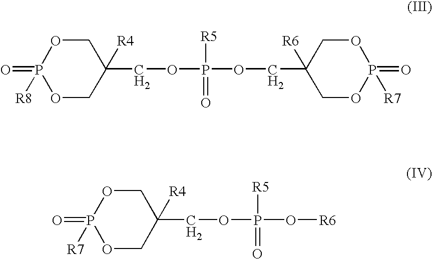

in which R4, R5, R6, R7 and R8 represent, independently of one another, a hydrogen atom or a linear or branched, substituted or unsubstituted and aliphatic, cyclic and/or aromatic hydrocarbon group comprising from 1 to 10 carbon atoms, preferably from 1 to 4 carbon atoms, which can optionally comprise one or more heteroatoms.

Use is preferably made, as fire-retardant agent, of the methyl(5-ethyl-2-methyl-2-oxido-1,3,2-dioxaphosphorinan-5-yl)methyl ester of methylphosphonic acid (CAS No. 41203-81-0) and/or the bis((5-ethyl-2-methyl-2-oxido-1,3,2-dioxaphosphorinan-5-yl)methyl) ester of methylphosphonic acid (CAS No. 42595-45-9). The mixture of these compounds is sold under the name Antiblaze™ CU by Rhodia. Use may also be made of Antiblaze™ CT, comprising approximately 93% of Antiblaze™ CU and 7% of water.

The yarns, fibers and/or filaments according to the invention are based on a thermoplastic matrix.

The thermoplastic matrix is preferably composed of at least one thermoplastic polymer chosen from the group consisting of: polyamides, polyolefins, poly(vinylidene chloride)s, polyesters, polyurethanes, acrylonitriles, (meth)acrylate/butadiene/styrene copolymers, their copolymers and their blends.

Mention may be made, as examples of polymers composing the thermoplastic matrix, of: polyurethanes obtained by reaction between diisocyanates, such as 1,5-naphthalene diisocyanate, p-phenylene diisocyanate, m-phenylene diisocyanate, 2,4-toluene diisocyanate, 4,4′-diphenylmethane diisocyanate, 3,3′-dimethyl-4,4′-diphenylmethane diisocyanate, 3,3′-dimethyl-4,4′-biphenyl diisocyanate, 4,4′-diphenylisopropylidene diisocyanate, 3,3′-dimethyl-4,4′-diphenyl diisocyanate, 3,3′-dimethoxy-4,4′-biphenyl diisocyanate, dianisidine diisocyanate, toluidine diisocyanate, hexamethylene diisocyanate, 4,4′-diisocyanatodiphenylmethane and compounds of the same family, and diols comprising long linear chains, such as poly(tetramethylene adipate), poly(ethylene adipate), poly(1,4-butylene adipate), poly(ethylene succinate) or poly(2,3-butylene succinate); polyamides, such as poly(4-aminobutyric acid), poly(hexamethylene adipamide), poly(6-aminohexanoic acid), poly(m-xylylene adipamide), poly(p-xylylene sebacamide), poly(2,2,2-trimethylhexamethylene terephthalamide), poly(meta-phenylene isophthalamide), poly(p-phenylene terephthalamide) and polymers of the same family; polyesters, such as poly(ethylene azelate), poly(ethylene 1,5-naphthalate), poly(1,4-cyclohexanedimethylene terephthalate), poly(ethylene oxybenzoate), poly(para-hydroxybenzoate), poly(1,4-cyclohexylidenedimethylene terephthalate), poly(ethylene terephthalate), poly(butylene terephthalate), poly(trimethylene terephthalate) and polymers of the same family; vinyl polymers and their copolymers, such as poly(vinyl acetate), poly(vinyl alcohol), poly(vinyl chloride), polyvinyl butyral, poly(vinylidene chloride), ethylene/vinyl acetate copolymers and polymers of the same family; acrylic polymers, polyacrylates and their copolymers, such as poly(ethyl acrylate), poly(n-butyl acrylate), poly(methyl methacrylate), poly(ethyl methacrylate), poly(n-butyl methacrylate), poly(n-propyl methacrylate), polyacrylamide, polyacrylonitrile, poly(acrylic acid), ethylene/acrylic acid copolymers, ethylene/vinyl alcohol copolymers, acrylonitrile copolymers, methyl methacrylate/styrene copolymers, ethylene/ethyl acrylate copolymers, methacrylate/butadiene/styrene copolymers, ABS and polymers of the same family; polyolefins, such as low density polyethylene, polypropylene, chlorinated low density polyethylene, poly(4-methyl-1-pentene), polyethylene, polystyrene and polymers of the same family; polyurethanes, such as polymerization products of diols, such as glycerol, trimethylolpropane, 1,2,6-hexanetriol, sorbitol, pentaerythritol, polyether polyols, polyester polyols and compounds of the same family, with polyisocyanates, such as 2,4-tolylene diisocyanate, 2,6-tolylene diisocyanate, 4,4′-diphenylmethane diisocyanate, 1,6-hexamethylene diisocyanate, 4,4′-dicyclohexylmethane diisocyanate and compounds of the same family; their copolymers and their blends.

Preferably, the thermoplastic matrix according to the invention is composed of a thermoplastic polyamide chosen from the group consisting of: polyamide-6, polyamide-6,6, polyamide-4,6, polyamide-6,10, polyamide-6,12, polyamide-11, polyamide-12, their copolymers and/or their blends; copolyamide-6/6,6, copolyamide-6/6,9, copolyamide-6/6,10, copolyamide-6/6,18, copolyamide-6/6,36 and/or their blends; the blends of polyamide-6 and polyamide-6,6, polyamide-6 and polyamide-6/6,18, polyamide-6 and polyamide-6/6,36, polyamide-6 and polyamide-6/6,10 and/or their blends.

According to a specific alternative form of the invention, the thermoplastic matrix is a polymer comprising star-shaped or H-shaped macromolecular chains and, if appropriate, linear macromolecular chains. The polymers comprising such star-shaped or H-shaped macromolecular chains are disclosed, for example, in the documents FR 2 743 077, FR 2 779 730, U.S. Pat. No. 5,959,069, EP 0 632 703, EP 0 682 057 and EP 0 832 149. The thermoplastic matrix of the invention can also be a polymer of random tree type, preferably a copolyamide exhibiting a random tree structure. These copolyamides with a random tree structure and their process of preparation are disclosed in particular in the document WO 99/03909. The thermoplastic matrix of the invention can also be a composition comprising a linear thermoplastic polymer and a star-shaped, H-shaped and/or tree thermoplastic polymer as are described above. The thermoplastic matrix of the invention can also comprise a hyperbranched copolyamide of the type of those described in the document WO 00/68298. The thermoplastic matrix of the invention can also comprise any combination of star-shaped, H-shaped or tree thermoplastic polymer or hyperbranched copolyamide described above.

The thermoplastic matrix can also comprise additives, such as pigments, delustrants, mattifying agents, catalysts, heat and/or light stabilizers, fire-retardant agents, bactericides, fungicides and/or acaricides. It can, for example, be a mattifying agent, for example chosen from particles of titanium dioxide and/or of zinc sulfide.

The present invention also relates to yarns, fibers and/or filaments having a good level of fire retardancy comprising a low proportion of fire-retardant agent, for example from 0.01 to 5% by weight, preferably from 0.02 to 3% by weight, of fire-retardant agent, with respect to the total weight of the yarns, fibers and/or filaments.

The fire-retardant yarns, fibers and/or filaments according to the invention advantageously comprise a fire-retardant agent chosen from organic or inorganic phosphorus compounds, said yarns, fibers or filaments comprising from 0.001 to 1% by weight, preferably from 0.005 to 0.2% by weight, of phosphorus originating from the fire-retardant agent or from its derivatives, with respect to the total weight of the yarns, fibers or filaments.

The present invention also relates to textile articles comprising at least fire-retardant yarns, fibers and/or filaments as described above. The term “textile article” is understood to mean an object made of textile material comprising at least one textile surface as defined above.

Mention may be made, as articles, for example, of woven, nonwoven and/or knitted articles. These articles can also comprise other components. These components can be, for example, short fibers, backings or articles obtained from yarns, fibers or filaments, such as nonwoven articles. The yarns, fibers, filaments and/or articles can be employed in the manufacture of any product, such as, for example, carpets, including fitted carpets, furniture coverings, surface coverings, sofas, curtains, bedding, mattresses and pillows, clothes and textile materials for medical use. For the manufacture of fibers, the filaments can, for example, be gathered together in the form of a roving or lap, directly after spinning or during the taking up, drawn, textured and chopped. The fibers obtained can be used for the manufacture of nonwovens or staple fiber yarns. The compositions can also be used for the manufacture of flock tows. The yarns, fibers and filaments and the articles obtained from the yarns, fibers and filaments can be dyed. The dyeing processes mentioned are in particular bath or jet dyeing processes. The preferred dyes are metalliferous or nonmetalliferous acid dyes.

Another subject matter of the present invention is the use of at least one fire-retardant agent and/or one composition comprising at least one fire-retardant agent in the coating of yarns, fibers and/or filaments during the progression of the yarns, fibers and/or filaments during the processes for the manufacture and/or treatment thereof.

Another subject matter of the present invention is a sizing composition comprising at least one fire-retardant agent and one compound which modifies the surface properties of the yarns; fibers and/or filaments.

The sizing composition can comprise in particular lubricating agents, agents which make it possible to give cohesion between the filaments and relatively high stiffness to the yarn, such as polymeric tacky film-forming compounds, such as, for example, poly(vinyl acetate), polyesters, epoxides or copolymers, bridging agents, for promoting the bonding of the yarns with other compounds, such as glass, and/or antistatic agents, for removing electrostatic charges.

The invention also relates to the use of a sizing composition comprising at least one fire-retardant agent in the manufacture of fire-retardant yarns, fibers and/or filaments.

A specific language is used in the description so as to facilitate the understanding of the principle of the invention. Nevertheless, it should be understood that no limitation on the scope of the invention is envisaged by the use of this specific language. Modifications, improvements and refinements can in particular be envisaged by a person conversant with the technical field concerned on the basis of his own general knowledge.

The term “and/or” includes the meanings “and”, “or” and all the other possible combinations of the elements connected to this term.

Other details or advantages of the invention will become more clearly apparent in the light of the examples given below solely by way of indication.

### EXPERIMENTAL PART

### Example 1

### Sizing composition

Various sizing compositions were prepared by mixing the various compounds mentioned in the following table:

TABLE 1

| Sizing composition | Compounds |
|---|---|
| A | 9.7% Antiblaze ™ CT; 4.4% oil |
| B | 7% Antiblaze ™ CT; 7% oil |
| C | 9.7% Antiblaze ™ CT; 4.4% oil |
| D | 13.6% Antiblaze ™ CT |

The percentages are expressed by weight with respect to the total weight of the sizing composition. The remainder of the sizing composition is composed of water.

Antiblaze™ CT is sold by Rhodia, Antiblaze™ CT corresponding to 93% of Antiblaze™ CU and 7% of water.

The oils correspond to a mixture based on ethylhexyl stearate (debonder from Takaemoto Delion® S6131).

### Example 2

### Preparation of the Samples

A) Spinning

A standard polyamide-6,6 having a relative viscosity of 2.6 (measured at 1 g/100 ml in 96% sulfuric acid at 25° C.) is dried conventionally in order to obtain a residual moisture content of 0.09%.

It is melted in an extruder and spun in two spinnerets each having 20 spinneret holes, thus creating 20 filaments, which are cooled by blowing (20° C., relative humidity 66%). The filaments are then gathered together, so as to obtain a yarn comprising 40 filaments.

The sizing composition A or B mentioned in table 1 is subsequently deposited on the yarn.

The resulting partially oriented yarn (POY) thus obtained is collected on a tube using a winding machine rotating at 4200 meters/minute and is stored for two weeks.

The characteristics of the yarn are as follows:

| | |
|---|---|
| Spinning count (dtex) | 96 ± 3 |
| Breaking force (cN/tex) | 30 ± 3 |
| Breaking elongation (%) | 65 ± 3 |
| Level of sizing agent (%) | 0.7 ± 1 |

The count is measured according to Standard UNI EN ISO 2060. The breaking force and the breaking elongation are measured according to Standard UNI EN ISO 2062.

The POY yarn thus has a count of 98 and is composed of 40 filaments. The yarn will be referred to as POY 98f40 yarn. The POY yarn can be textured so as to have 1 end or 2 ends.

B) Texturing:

The POY yarn is textured on the Giudici TG30 texturing machine under the following conditions:

| | |
|---|---|
| Draw ratio | 1.26 |
| Speed (m/min) | 500 |
| Temperature (° C.) | 210 |
| D/Y ratio (twist level) | 1.70 |
| Disk setup | 1-5-1 (ceramic disks) |

The mechanical characteristics obtained with regard to textured yarns are as follows:

| | |
|---|---|
| Count (dtex) | 78 ± 3 |
| Breaking force (cN/tex) | 30 ± 3 |
| Breaking elongation (%) | 65 ± 3 |

A 78f40 yarn is thus obtained.

C) Knitting

The textured yarn is knitted on a Santoni machine with a single knitting needle bed (single knitting head) over all the feeders in jersey weave.

D) Dyeing and Finishing

The knitted fabrics obtained are finished and dyed according to the following procedures: Ecru (without any treatment), T-S-D or S-D.

T corresponds to heat-setting at 188° C. for 30 minutes.

S corresponds to washing at 60° C. for 20 minutes with 1 g/l of anionic detergent (Invatex CRA from Ciba) and a pH of between 7 and 10.

D corresponds to dyeing at 98° C. for 45 minutes with 1% of Nylosan Blue NBLN (Clariant), 1% of Sandogen NH (leveling agent from Clariant), 1 g/l of Sandacid VA (acid donor from Clariant) and 0.5 g/l of sodium acetate.

Measurement After Washing the Articles

The proportion of phosphorus was measured according to the following standard, FRAS-100 from Albright & Wilson, before and after 50 washing operations at a temperature of 40° C.

The only source of phosphorus originates from the fire-retardant agent Antiblaze™ CU.

1 g of yarn is placed in a Phillips 250 ml mill. 5 ml of sulfuric acid (sg 1.84) are subsequently added. Heating is carried out until carbonization has occurred and oxidation is subsequently carried out by dropwise addition of nitric acid (sg 1.42). This is continued until no carbonization is apparent. Cooling is subsequently carried out and 1 ml of nitric acid (sg 1.42) and 1 ml of perchloric acid (60%) are added. Heating is carried out, so as to evaporate the sulfuric acid. Cooling is carried out and 100 ml of deionized water and 0.5 g of ammonium persulfate are added. Heating at reflux is carried out for 30 minutes, 1 ml of hydrochloric acid (sg 1.18) is added and heating at reflux is carried out for a further 30 minutes.

Cooling is carried out, all the contents are transferred into a 250 ml volumetric flask and dilution up to the mark is carried out with deionized water.

20 ml of the preceding solution are then recovered, are transferred into a 200 ml volumetric flask and are diluted up to the mark with deionized water.

The percentage of phosphorus is analyzed in an autoanalyzer with vanadomolybdate as reagent. The intensity is measured at 420 nm.

The data are listed in table 2 according to the sizing composition used and the various treatments (texturing, heat-setting, desizing, dyeing).

TABLE 2

| | | Texturing | | Without | After |
|---|---|---|---|---|---|
| | Sizing | (number | | washing | washing |
| Sample | composition | of ends) | Treatments | % P | % P |
| 1 | A | 1 | S-D | 0.006 | 0.006 |
| 2 | A | 1 | T-S-D | 0.010 | 0.011 |
| 3 | A | 2 | S-D | 0.007 | 0.006 |
| 4 | A | 2 | T-S-D | 0.011 | 0.014 |
| 5 | A | 1 | Ecru | 0.240 | 0.020 |
| 6 | A | 2 | Ecru | 0.180 | 0.020 |
| 7 | B | 1 | S-D | 0.009 | 0.008 |
| 8 | B | 1 | T-S-D | 0.008 | 0.009 |
| 9 | B | 2 | S-D | 0.008 | 0.008 |
| 10 | B | 2 | T-S-D | 0.012 | 0.010 |
| 11 | B | 1 | Ecru | 0.150 | 0.019 |
| 12 | B | 2 | Ecru | 0.160 | 0.016 |

Thus, it is apparent that the yarns of the knitted fabrics obtained from yarns comprising the fire-retardant agent resist very well after 50 washing operations at 40° C.

Measurement of the Fire Retardancy

Samples with a length of 200 mm and a width of 80 mm are subjected to a fire-retardancy test according to Standard EN 533. A butane gas flame with a length of 45 mm is placed horizontally at a distance of 45 mm from the edge of a sample for 10 seconds.

For the fire-retardancy measurements, the knitted articles are tested in the direction of the wales and in the direction of the courses.

After a fire-retardancy period of 10 seconds on the samples, the duration in seconds of residual flame and the length of carbonization of the samples are measured.

The articles according to the invention were compared with articles obtained from comparative yarns which are not fire-retardant.

Comparative 1: White POY 78f40 yarns
Comparative 2: Blue desized and dyed 78f40 yarns

Comparative 3: Blue heat-set, desized and dyed 78f40 yarns

The results are given in table 3.

TABLE 3

| | | Course direction | | Wale direction | |
|---|---|---|---|---|---|
| | | | Length of | | Length of |
| | | Duration | carboni- | Duration | carboni- |
| | Number of | of the | zation | of the | zation |
| | washing | flame | (milli- | flame | (milli- |
| Sample | operations | (seconds) | meters) | (seconds) | meters) |
| 3 | 0 | 0.0 | 82.0 | 0.0 | 77.0 |
| 4 | 0 | 0.0 | 77.0 | 0.0 | 89.0 |
| 9 | 0 | 0.0 | 82.0 | 0.0 | 82.0 |
| 10 | 0 | 0.0 | 83.0 | 0.0 | 83.0 |
| 3 | 5 | 0.0 | 58.0 | 0.0 | 72.0 |
| 4 | 5 | 0.0 | 62.0 | 0.0 | 68.0 |
| 9 | 5 | 0.0 | 55.0 | 0.0 | 69.0 |
| 10 | 5 | 0.0 | 55.0 | 0.0 | 73.0 |
| 3 | 50 | 0.0 | 73 .0 | 0.0 | 105.0 |
| 4 | 50 | 0.0 | 62.0 | 0.0 | 77.0 |
| 9 | 50 | 0.0 | 76.0 | 0.0 | 83.0 |
| 10 | 50 | 0.0 | 76.0 | 0.0 | 78.0 |
| Comp. 1 | 0 | 2.0 | 61.0 | 9.0 | 130.0 |
| Comp. 2 | 0 | 20.0 | 101.0 | 8.0 | 115.0 |
| Comp. 3 | 0 | 10.0 | 70.0 | 2.0 | 62.0 |

Thus, it is apparent that the textile articles obtained from yarns comprising a fire-retardant agent exhibit good fire retardancy even after 50 washing operations at 40° C.

1-26. (canceled)

27. A process for the manufacture of fire-retardant yarns, fibers and/or filaments based on a thermoplastic matrix, comprising the step of depositing at least one fire-retardant agent and/or one composition comprising at least one fire-retardant agent on the yarns, fibers and/or filaments during their progression during the processes for the manufacture and/or treatment thereof.

28. The process as claimed in claim 27, wherein said deposition is carried out during a step of spinning the yarns, fibers and/or filaments, between the departure from the spinneret of the thermoplastic matrix and the winding up of the yarns, fibers and/or filaments obtained.

29. The process as claimed in claim 28, wherein said deposition is carried out after the convergence of the yarns, fibers and/or filaments.

30. The process as claimed in claim 28, wherein said deposition is carried out during a stage of drawing the yarns, fibers and/or filaments.

31. The process as claimed in claim 28, further comprising the step of depositing a sizing composition comprising at least one fire-retardant agent on the yarns, fibers and/or filaments.

32. The process as claimed in claim 31, wherein the sizing composition comprises from 0.1 to 30% by weight of fire-retardant agent, with respect to the total weight of the composition.

33. The process as claimed in claim 27, wherein said deposition is carried out during a treatment stage during the taking up of the yarns, fibers and/or filaments.

34. The process as claimed in claim 33, wherein said deposition is carried out during an operation selected from the group consisting of: twisting, setting, crimping, drawing and/or texturing the yarns, fibers and/or filaments.

35. The process as claimed in claim 33, wherein a sizing composition comprising at least one fire-retardant agent is deposited on the yarns, fibers and/or filaments.

36. The process as claimed in claim 33, wherein the yarns, fibers and/or filaments are placed in a washing and/or dyeing composition comprising at least one fire-retardant agent.

37. The process as claimed in claim 27, wherein the fire-retardant agent is selected from the group consisting of an organic or inorganic compound based on magnesium, on aluminum, on nitrogen, on bromine, on chlorine, on sulfur and on phosphorus.

38. The process as claimed in claim 27, wherein the fire-retardant agent is selected from the group consisting of: magnesium hydroxide, aluminum hydroxide, aluminum phosphate, triazines, cyanuric acid, isocyanuric acid, melamine, melamine cyanurate, melamine oxalate, melamine phthalate, melamine borate, melamine sulfate, melamine phosphate, melamine polyphosphate, melamine pyrophosphate, melam, melem, melon, tris(hydroxyethyl) isocyanurate, benzoguanamine, guanidine, allantoin and glycoluril, PBDPO (polybromodiphenyl oxide), BrPS (polybromostyrene and brominated polystyrene), poly(pentabromobenzyl acrylate), brominated indane, tetradecabromodiphenoxybenzene, 1,2-bis(pentabromophenyl)ethane, tetrabromobisphenol A, brominated epoxy oligomers, a chlorinated cycloaliphatic compound, thiourea, ammonium thiocyanate, ammonium, guanidine sulfamate, guanidine sulfamides, guanidine sulfonates, phosphoric acid, polyphosphoric acid, pyrophosphoric acid, phosphonic acid, phosphate, polyphosphate, triphosphorous acid, metaphosphoric acid, phosphorous acid, hypophosphorous acid, phosphinic acid, phosphorous ester, phosphinous acid, phosphorous oxide, phosphinic oxide, phosphorous trioxide, organic phosphites, trimethyl phosphite, phosphates, trialkyl phosphate, triaryl phosphate, organic phosphonates, alky phosphonates, aryl phosphonates, organic phosphinates, alkyl phosphinates and aryl phosphinates.

39. The process as claimed in claim 27, wherein the fire-retardant agent is an organophosphorus compound of formula (I) or (II): 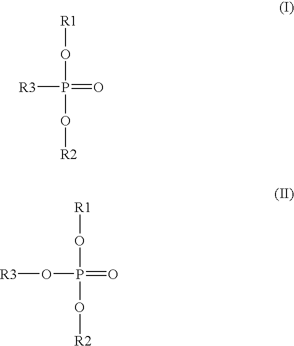
wherein R1, R2 and R3 represent, independently of one another, a hydrogen atom or a linear or branched, substituted or unsubstituted and aliphatic, cyclic and/or aromatic hydrocarbon group comprising from 1 to 20 carbon atoms optionally having one or more heteroatoms.

40. The process as claimed in claim 27, wherein the fire-retardant agent is an organophosphorus compound of formula (III) or (IV): 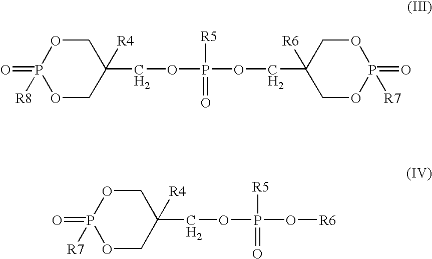
wherein R4, R5, R6, R7 and R8 represent, independently of one another, a hydrogen atom or a linear or branched, substituted or unsubstituted and aliphatic, cyclic and/or aromatic hydrocarbon group comprising from 1 to 10 carbon atoms optionally having one or more heteroatoms.

41. The process as claimed in claim 27, wherein the fire-retardant agent is the methyl(5-ethyl-2-methyl-2-oxido-1,3,2-dioxaphosphorinan-5-yl)methyl ester of methylphosphonic acid or the bis((5-ethyl-2-methyl-2-oxido-1,3,2-dioxaphosphorinan-5-yl)methyl) ester of methylphosphonic acid.

42. The process as claimed in claim 27, wherein the thermoplastic composition comprises at least one thermoplastic polymer selected from the group consisting of: polyamides, polyolefins, poly(vinylidene chloride)s, polyesters, polyurethanes, acrylonitriles, (meth)acrylate/butadiene/styrene copolymers, their copolymers and their blends.

43. The process as claimed in claim 27, wherein the thermoplastic composition comprises a thermoplastic polymer selected from the group consisting of:
polyamide-6, polyamide-6,6, polyamide-4,6, polyamide-6,10, polyamide-6,12, polyamide-11, polyamide-12, their copolymers and/or their blends; copolyamide-6/6,6, copolyamide-6/6,9, copolyamide-6/6,10, copolyamide-6/6,18, copolyamide-6/6,36 and/or their blends; the blends of polyamide-6 and polyamide-6,6, polyamide-6 and polyamide-6/6,18, polyamide-6 and polyamide-6/6,36, polyamide-6 and polyamide-6/6,10 and their blends.

44. A fire-retardant yarn, fiber and/or filament, comprising from 0.01 to 5%, optionally from 0.02 to 3%, by weight of fire-retardant agent, with respect to the total weight of the yarn, fiber and/or filament.

45. A fire-retardant yarn, fiber and/or filament comprising at least one fire-retardant agent chosen from organic or inorganic phosphorus compounds, wherein said yarn, fiber or filament comprises from 0.001 to 1%, optionally from 0.005 to 0.2%, by weight of phosphorus originating from the fire-retardant agent or from its derivatives, with respect to the total weight of the yarn, fiber or filament.

46. A textile article, comprising at least one yarn, fiber and/or filament as claimed in claim 44.

47. A sizing composition, comprising at least one fire-retardant agent and one compound which modifies the surface properties of the yarns, fibers and/or filaments.

48. The sizing composition as claimed in claim 47, comprising from 0.1 to 30% by weight of fire-retardant agent, with respect to the total weight of the composition.
